(19) United States
(12) Patent Application Publication
(10) Pub. No.: US 2008/0223359 A1
(43) Pub. Date: Sep. 18, 2008

(54) Energy Efficient Cookware

(76) Inventor: Lee Lisheng Huang, (US)

Correspondence Address: Lee Huang, 550 Irven Court, Palo Alto, CA, 94306, US

(21) Appl. No.: 12/114,769

(22) Filed: May 3, 2008

Related U.S. Application Data
(63) Continuation-in-part of application No. 11/992,972.
(60) Provisional application No. 60/869,370, filed on Dec. 11, 2006.

(51) Int. Cl. A47J 27/02; A47J 36/02

(52) U.S. Cl. 126/390.1

(57) ABSTRACT

Energy efficient cookware is provided includes a base and a wall, a linear pattern of flame guide channels connected to the base bottom. The guide channels accept a flame and guides it to the perimeter from the central region resulting efficient heat exchange; The linear channel profiles provides maximum the surface enhancement from a given plain area on the bottom to improve heat transfer while provides even heating, and mechanical strength to the cookware; The impedance to entrance of flame flow into the channels is minimized to allow easy entrance of the flame into the channels; A square base further extends the linear channel length to gain extra efficiency. A method of making the efficient cookware is provided involving welding an extruded channel base to a wall.

### RELATED US APPLICATION DATA

Continuation-in-part of application Ser. No. 11/992,972, filed on Mar. 31, 2008, which is continuation-in-part of application No. PCT/US/2007/007279, filed on Mar. 23, 2007, which claims priority date of provisional application No. 60/869,370, filed on Dec. 13, 2006

### FIELD OF THE INVENTION

The invention relates generally to cookware. More particularly, the invention relates to heat transfer from a heating element to cookware, especially from a flame during the cooking process.

### BACKGROUND

Cookware is a basic tool used daily in human life. Regardless the different shapes of cookware, ranging from a barbecue grill to a wok and to a teapot, the basic elements of a cookware are two surfaces: one for receiving heat from heat source, the other for heating the food. Heat energy generated either from electricity, or a burning flame, is transferred from the source to the heat-receiving surface of the cookware, conducted through the cookware and transferred to the food. In general the heat transfer is not very efficient from combustion sources. The utilization of thermal energy from gas on a typical gas range for heating up a cookware is reported to be only about 30%. This means a lot of energy is wasted during the cooking process. As a result people pay unnecessarily high energy bill and lot of unnecessary undesirable CO₂ being emitted to the environment.

Effort has been directed to optimize the burner to have good mix of air and fuel gas in order to complete combustion of the fuel. Also attention has been paid to distribute the heat evenly across the base of a cookware. However with respect to combustion cooking, there has been limited effort made to improving the energy receiving end of the process, where the energy transfer efficiency from the flame to the cookware is typically low. Some attempt teach concentric grooves on the bottom surface of the cookware, and coating them with radiation absorbing coating to improve the heat absorption (U.S. Pat. No. 4,926,843), U.S. Pa. No. 5,396,834). These approaches are considered useful for hot-plate type cooking ranges. Other attempts provide cookware with patterned features that can improve the heat transfer laterally, its primary aim is to improve electric-source heat at the center and bottom of the cookware (U.S. Pat. No. 614,028). Another attempt has been made to improve heat conduction by using concentric rings in the cookware base. However the shallow grooves have demonstrated limited improvement on heat transfer (U.S. Pat. No. 5,411,014). When used with a flame-source, the proposed concentric rings are perpendicular to the flow of the flames and impede flame contact with the bottom surface. As a result the flow of the flame will go up and down over the rings increasing the inter mixing of the cool air with the hot flame reducing the efficiency of heat transfer. Patent (U.S. Pat. No. 7,150,279) also mentions using more thermal conductive material on the bottom to improve efficiency. However the efficiency of cookware over a gas range by far on the market has been about 30%.

Another issue associated with cookware is that the bottom of the cookware can be warped due to heating unevenly especially when stainless steel is the cookware material. The thermal conductivity of stainless is very low, which makes the severe local heating to warp the base. So the lifetime of the cookware is therefore compromised. Effort has been put in to increase the strength of the bottom of the cookware. For example, a cookware patent (U.S. Pat. No. 6,926,971) using multi-cladding metal for uniform heating is awarded to All-Clad, and Patent (U.S. Pat. No. 5,564,589) provides a convex shape to strengthen the bottom.

Therefore, it would be considered an advance in the art to provide significant improvement in efficiency in cookware, used with a combustion heat source, by promoting interaction of flame with the cookware surface to improve heat transfer from flame to cookware, at the same time help improve heating uniformity across the base, and provide stronger mechanical integrity to the cookware.

It would be also considered an advance in the art to provide an efficient manufacturing process to achieve the efficient cookware with such heat transfer enhancement features. Such advances would reduce fuel consumption, and CO₂ emissions.

### SUMMARY OF THE INVENTION

A cookware body typically has a base and a wall, where the wall extends from the top side of the base and spans a perimeter of the base. In the patent application (application Ser. No. 11/992,972) by the present inventor suggests a new type of cookware to has at least one pattern of flame guide channels connected to base of the cookware, wherein the flame guide channel is made from a pair of guide fins. The guide fins have a flame entrance end near a center region of the base, and have a flame exit end positioned towards the perimeter of the base. The invention further has at least one pattern of perturbation channels, where the perturbation channel is made from a pair of perturbation fins. The perturbation fins have a first perturbation end positioned away from the central region and a second perturbation end positioned towards the cookware perimeter. The flame guide channel accepts a flame from a stove burner and guides it towards the perimeter from the central region. The perturbation fin generates lateral turbulence in the guided flame by interfering with an onset of laminar flow in the flame as the flame moves along the guide channel. The induced turbulence increases heat transfer from the flame to the base and fins, while minimizing mixing of the flame with ambient air. Such induced turbulence promotes conduction of the flame heat through the cookware and to food for more efficient cooking.

In addition to the perturbation feature in the channels in the application Ser. No. 11/992,972, the present invention provides pattern of linear guiding channels with maximized extended channel surface density for given original heat receiving surface.

One aspect of the invention is to provide a channel width variation profile that will allow easy entrance of the hot flames into channels for efficient heat exchange. To further facilitate the flame to entrance the channel, the tips of the fins forming the channel are rounded and pointy to reduce flow entrance impedance.

Another aspect of the current invention, a square cookware base is proposed to provide to extra the heat exchange path to increase the heat exchange efficiency. The square base shape also maximizes the material utilization during a preferred manufacturing process to reduce energy used.

Another aspect of the invention is to provide linear fin structure continuous across the whole base, to allow not only good heat conduction to the bottom of the cookware to reach the food medium in upward direction, but also to have good heat conduction in side way direction to provide even heating over the bottom face of the cookware. This continuous structure also strengthens the base of the cookware to reduce the chance of warping and therefore enhances the lifetime of the cookware.

In a further aspect, the handles of the cookware are placed on the wall such that they are away from the exits of the linear channels to reduce the chance of being over heated by stray flame.

The present invention also provides a manufacturing process that can produce the cookware with high density of extended exchange channels cost effectively using the good thermally efficient material.

The present invention also provides a manufacturing process to produce the stainless steel cookware with linear heat exchange channels on the bottom.

### BRIEF DESCRIPTION OF THE FIGURES

The objectives and advantages of the present invention will be understood by reading the following detailed description in conjunction with the drawing, in which:

FIG. 1 shows a radial pattern of heat exchange channels

FIG. 2 shows a cookware with linear pattern of channels

FIG. 3 shows a square base cookware with linear pattern of channels

FIG. 4.1 shows guide fins with flat top

FIG. 4.2 shows guide fins with rounded top

FIG. 5 shows channel width varies across the base

FIG. 6 shows a setup for press bonding process

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

Typically cooking setup using combustion range is that a cookware holding a medium such as water is placed on top of a flame from a burner; The flame rises up due to pressure of the gas in the supply piping and the buoyancy of the hot air causes it to touch the base of the cookware; Heat transfer from the flame to the base occurs via convection transfer as well as radiation; The heat absorbed from the heat-receiving surface is transferred to the food surface by thermal conduction; The heat is then transfer from the food surface to the water via conduction and convection. In this whole process, the heat transfer from the flame to the cookware body via convection transfer is the most inefficient step limited by thick layer of boundary layer of the flame flow, while the heat transfer from the cookware the content is the next inefficient also limited by boundary layer of the liquid content. The heat conduction in the cookware body which typically metal and tends to be efficient.

A radial heat exchange channel pattern described in the patent application Ser. No. 11/992,972 is shown in FIG. 1. This is the bottom view of cookware 101. There is a pattern of channels formed by fins which is protruding upward from the base of the cookware. For example, fins 102 and 103 form a channel in the space between them. The channel is defined as the space in between a pair of fins and the base along the direction of the fins. The aspect ratio between the height of the fins and the distance between the fins is larger than one to be considered guiding channel to have recognizable channel guiding heat exchange effect. In a radial pattern in FIG. 1, the channel width will change along the path due to the radial nature. As indicated in the figure, the width of the channel at location 111 is larger than the location 112 which is closer to the center of the radial pattern. However, for a given manufacturing method, there is limit on how small the gaps and fins width can be achieved. This determines the surface area enhancement from exchange channel compared to the flat surface. It will be preferable to have channel width to be all at the minimum width allowed by the manufacturing process. The non-uniform channel width property of the radial pattern makes it not possible to realize the maximum surface area improvement that a given manufacturing process can provide.

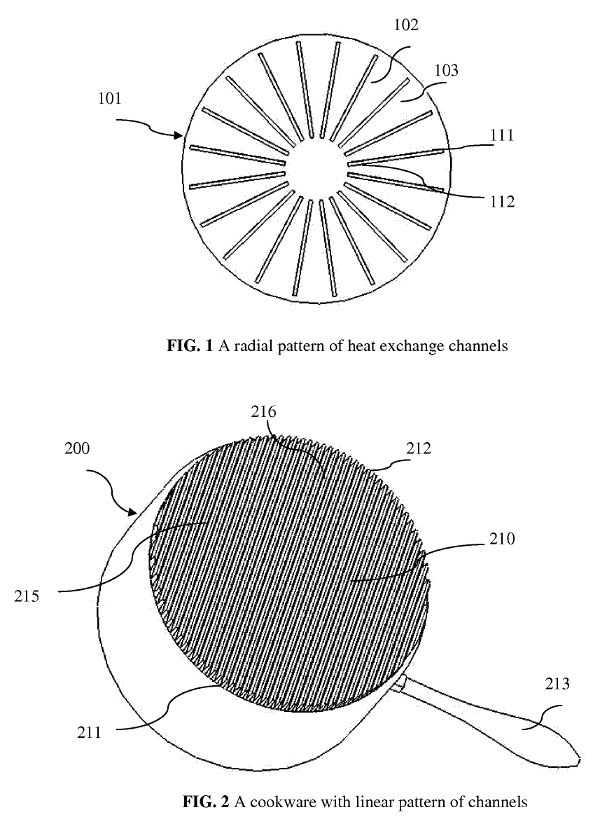

One the other hand, a linear pattern heat sink structure, the channel spacing is constant. Therefore it is possible to have it made channels across the whole base of the cookware with the smallest dimension a given manufacturing process can produce. This linear pattern can create the most surface area improvement in a channel format over the original flat surface for a given size of the flat surface area. A cookware with a linear pattern heat exchange channels is shown in FIG. 2. A cookware 200 comprises a linear channel pattern of channels 210. The channel width is constant along the length of the channels. Typical flame from a burner will be placed close to the center region of the cookware. Once it entrance to the channel, it will be guided to flow towards the perimeter of the base of the cookware. Eventually it exits the channel in the place indicated by 211 and 212. The material of fins has high thermal conductivity coefficient, therefore heat absorbed by the fin can be conducted to the base to help the overall heat transfer from the flame to the body of the cookware. This effectively increases the heat exchange surface area for the energy from hot flame to the body of the cookware. The dense channel arrangement from linear pattern of parallel fins provides a substantial improvement as shown in prototype built. A design of an aluminum cookware with guide fins of a width of 0.08 inch, a gap of 0.15 inch and a height of 0.5 inch results in about 50% cooking time compared with a same size conventional cookware without the exchange channels. This significantly improves energy utilization in cooking and reduces CO₂ emission.

Also seen in FIG. 2, a handle 213 is placed on the wall in the direction away from the output of the channels. The handle won't get heat up by flame escaping out in this direction otherwise without the confining channels. This is an improvement that can reduce risk of burning hands.

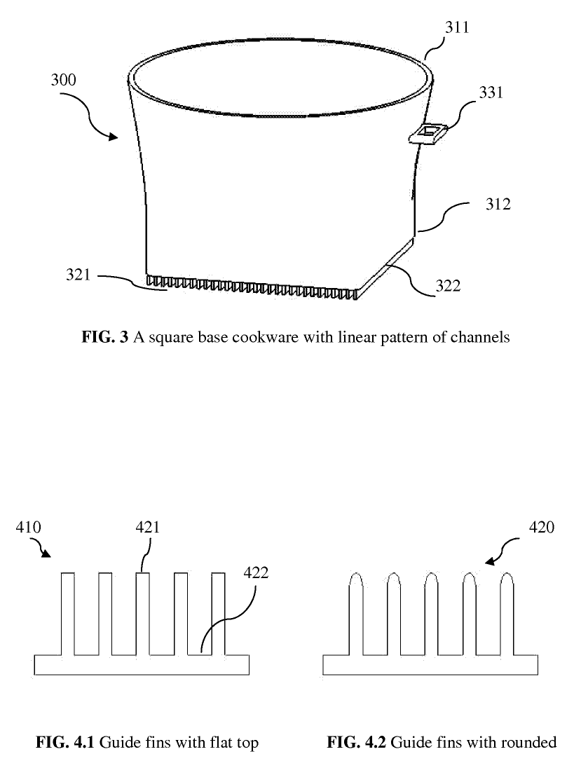

It is also found in experiments that the improvement of a 8 inch square base cookware with heat transfer channels over a 8 inch square base cookware without heat transfer channels is substantial bigger ˜10% than an improvement from a 8 inch round base cookware with the same heat transfer channels over a round base cookware without the heat transfer structures. The channel design in both cases is the same: width of the channel is 0.15 inch, the fin width is 0.08 inch and the height is 0.5 inch. This result indicates that the extra channel length at the corner of the square base cookware confine the flame for heat exchange while in the round base cookware the channels at the edge of the base run off quickly. Since the effective heat exchange happens inside the exchange channel, the extra channel length at the corners is what makes the difference. This effect can be significant on a range which flame speed is fast therefore the complete combustion of the flame happens a distances away from the exit of the fuel gas from the burner. To have a normal round cookware look, a design of the square base cookware can have round top opening. FIG. 3 depicts such cookware. The cookware 300 is morphed from a round top 311 to a square base 312. This can be done by standard progressive stamping manufacturing process. The exchange channels 321 are built to be in parallel to one of the edge 322 of the square base. This parallelism will give extra run way of the channel in the corner area to benefit energy exchange. A handle 331 is attached on the wall in area above the edge 322 which the heat exchange channels are made parallel to. Since hot flame is guided to flow along the direction of the edge 322, the handle 331 will have less chance to get heat up by the flame.

To have efficient heat exchange in the channels, hot flame must be allowed to flow into channels freely without too much impedance. It is found in that this requirement need to be balanced with the need of enhancement of surface area. To have large surface area enhancement, it is desirable to have dense fins which leads to thinner fins and therefore narrower channel widths. However if the width of the channel is too narrow, it will limits the ability of hot flame to entrance into the channels. The ratio between the thickness of the fin ω_{f} the effective width of the fin at the entrance, and the width of the channels ω_{c} is defined as the impedance ωₑ to the flame entrance to the channels, Ωₑ=ω_{f}/ω_{c}. To reduce the flame entrance impedance, the thickness of the fin should be small. However, when the fin is too thin it will be easier to be damaged during the daily use in a commercial kitchen; even the heat transfer efficiency from the height of the fins to the base can be comprised. So it will prefer to reduce the impedance while retain the strength of the fins. One way to reduce the impedance is to sharpen the top of the fin such as rounding, and tapering. FIG. 4.1 shows a fin structure 410 where the fin width is denoted as 411 and the channel width is 412. The typical of the fin top is flat; the impedance of the air can be represented by the ratio of fin width 411 over channel width 412. As shown in the FIG. 4.2 the top of the fins in fin structure 420 are round up. The top of the fins is smaller making the effective width of the fin smaller therefore reducing the impedance for hot flame to entrance to the channel.

The flame flow entrance impedance to the channels plays important role in the efficiency of the cookware. In an experiment, a cookware with guide fins width of 0.08 inch, gap of 0.1 inch and height of 0.5 inch was tried out. This channel fin density is higher than the one with guide fins width of 0.08 inch, gap of 0.15 inch and height of 0.5 inch described in the example in the previous example, therefore efficiency was expected to be higher. However the efficient dropped by 10% from the design result in 50% described above. This is because entrance impedance of the flame flow to the channel this one is 0.8 compared with 0.53 for the previous one. The high flow entrance impedance make the efficiency lower even the surface density is higher. By cutting 3 slots of 0.25 inch across the channels in the center region to facilitate the entrance of the flame does pull the efficiency back by 5%. This illustrates the importance of reducing the flame entrance impedance. In the manufacturing process, the number of the slots to open in the extruded channel need to minimized to be cost effective. So it is important to reduce the entrance impedance for efficient heat exchange.

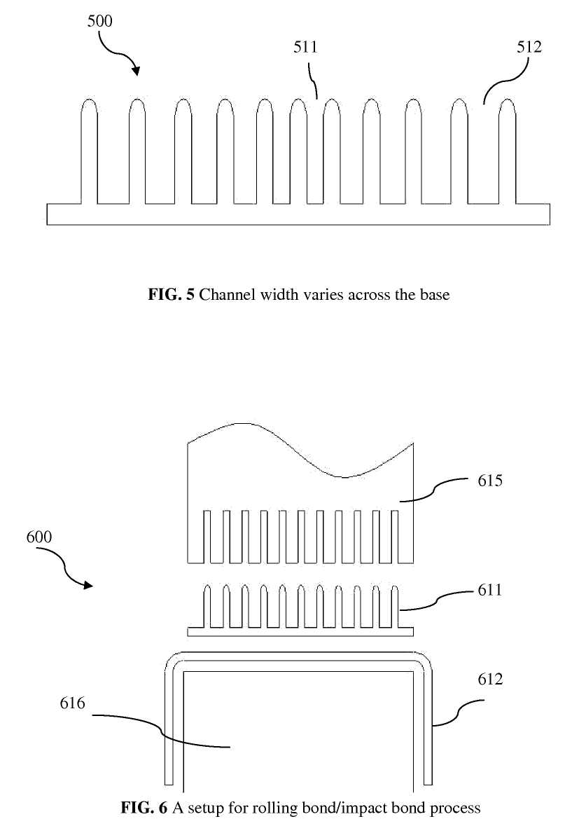

Besides the impedance, the entrance of the flame to the channel is also affected by the direction of the flame flow with respect to the direction of the channels. A typical burner generates a central symmetric flame. As the flame flows upward into the channels, it also flows outward in radial direction. As seen in FIG. 2, as the flame goes outwards, the outward flow velocity in region 215 is in general the direction of the channels. The flow can entrance into channels easily, and therefore the channel density can be made higher. On the other hand, in region of 216, the flow velocity flow is in general perpendicular to the direction of the channels. It is preferable to have the width of the channels to be larger in this region to be larger to allow the flow to entrance easier. Therefore a channel width profiles of which the width of the channels varies from the center in this direction can facilitate the entrance of the flame. FIG. 5 shows a channel pattern 500 where the channel width varies across the base. The channels in region 501 are in the same general direction of the flame flow, the channels width can be narrower to have denser fins therefore bigger surface area improvement. While in the region 502, the flame's radial flow component is pretty much perpendicular to the direction of the channel. Therefore it is preferable to have wider channels in this region to allow easier entrance of the flame flow into the channels. Different range burner from different vendors will have different flame flow profiles and temperature distributions. Therefore the variation in channel width should be optimized accordingly for different ranges.

In order to achieve the benefits of the energy efficient cookware in market place, it is important to be able to manufacture the heat exchange channel on cookware cost effectively and energy efficiently. One way to achieve a low cost linear channel structure is to via extrusion. Aluminum extrusion is a low cost manufacturing technique that routinely generates tons of aluminum structures in daily uses such as window frames, table frame, etc. Aluminum extrusion is capable of fabricating fine fins. On top of that, in an extrusion process, aluminum alloys with very good thermal conductivity can be use. For example Aluminum alloys such as 6063T5 which is 209 W/mK can be used in extrusion as compared with aluminum alloys A360, which is 130 W/mK, used in die cast process. Good thermal conductivity in the body of the cookware definitely needed for efficient heat transfer from the flame to the food medium therefore the cookware efficiency.

In process of making a stockpot of 12 inch diameter, the extrusion die is designed to be 12 inches wide. The fin width is about 0.08 inches and the channel width can vary from 0.1 inch to 0.2 inch in linear fashion. The fins are denser in center region than the region on the edges. The thickness of the extrude base is 0.125 inch. The extruded plate is typically about 12 feet long as drawn. Try to design it to be multiple of the diameter of the cookware base plus the slot width from cutting. The material used is 6063 aluminum alloy. The extruded plate is then cut in to 12 by 12 inches square base pieces. The square base plate is then machined to a round base. On the other hand the wall is fabricated by stamping. The bottom of the stamped container is then cut off or punched off. For small diameter cookware, the wall can also be fabricated by extrusion. Typical thickness of the wall is 0.125 inches. The base is then welded to the wall with the side of the base with heat exchange channel on is put to face the outside. Welding can be done using electric arc welding, laser welding, friction welding, fusion welding or blaze welding. For square base cookware, the wall will be especially deep drawn such that the top of the wall is circle while at the bottom it is square. The punch of the deep drawing machine will be square shape and the die used will be in circle. Care is needed to design the punch and the process of draw not to punch through the wall at corners areas. For square cookware, there is no need to cut the extruded square base to circle. This significantly reduces material scrap rate and lower the cost in manufacture. This is another benefit from square base.

To complete the cookware, one or two handles will be attached to the wall of the cookware for example by welding. The position of the handles will be placed on the wall that is away from the channel exits. This placement reduces the chance of the handle being heat up by the hot flame flow up due to buoyancy force along the wall of the cookware, since most of the flame will be guided toward the exits of the channels.

After the cookware body is made, it is preferable to hard anodize the inside of the cookware. The hard anodized layer is chemically inert to resist corrosion, and physically hard to withstand scratches. With hard anodized layer, the cookware can last longer. However the thermal conductivity of the Aluminum Oxide is only 25 W/mK, much lower than the 210 W/mK of Aluminum. The inside layer should be thick enough, larger than 20 μm, to have wear resistance and corrosion resistance, yet not to impact on the heat conductivity too much. For outside surface, it is preferable to roughen the surface in the outside surface, especially the channel area, by sand blasting, or other mechanical means. Surface texture can be also formed on surface of extruded channel base. For example, fine grooves can be put on the wall of the fins and base from extrusion by detailed design of extrusion die. From thermal conductivity point of view, it is preferable not to be anodized to keep the thermal conductivity of the aluminum material intact. However when considering that it is also beneficial to have an IR absorbing dark layer on the outside surface to improve the radiation thermal heat transfer. A thin anodized layer with IR absorbing dye can be added for improving radiation absorption at the same time provides some degree of protection from scratching and erosion.

Alternatively, a layer of stainless steel can be spray coated on the inside surface of the cookware. The thickness of the stainless steel layer again is optimized for wear and corrosion resistance and at the same time minimizing any impact on the thermal conductivity of the cookware.

Stainless steel cookware is widely used due to its robustness against corrosion, wear and tear. However it is its thermal conduction coefficient is poor. Also it is difficult to extrude stainless steel to make channels. One way to achieve efficient heat exchange channels on stainless steel cookware to help improve heat conduction is to attach a linear heat exchange channels plate made from Aluminum on the base of a stainless cookware. In this process, a plate having proper heat exchange channels on one side of the surfaces is obtained by extrusion. It is then cut in to shape of the base of the stainless cookware. The bonding surface, the opposite face to the face having the heat channels are wire wheel ground, or abraded to remove the surface oxide layer. The base of the stainless cookware is also roughen and cleaned. A rolling press bonding process is depicted in FIG. 6. Where an extruded plate 611 is heat up to 300C, a stainless cookware 612 is at 550C. The aluminum heat sink is then placed on the bottom of the stainless cookware. A roller 615 is rolling and pressing on the aluminum plate 611 against the stainless steel cookware 612 which is placed on stage 616 so that they can be bonded together. The roller 615 is specially shaped, i.e. having ridges pattern complimentary to the channel profile of the extruded aluminum plate. The roller press is exerting force via the ridges through the gaps between the fins on to the base of the heat sink when rolling over the whole plate. The force required from the rolling press is not as high as that is needed for an impact bonding process. The linear pattern of the heat exchange channels makes this roller press process possible. Alternatively the heat sink can be pressed on to the bottom of the stainless steel cookware by high pressure impact bond. The process can also be represented by FIG. 6. The press 615 is a press die pressing down on whole base at a same time instead of rolling. There are linear ridges on the die having pattern complementary to the channel structure on the extruded aluminum channel plate. The process of high pressure friction bond/impact bond is disclosed in U.S. Pat. No. 4,552,284. A twisting action can be added during the impact to improve the bonding.

All the above descriptions are considered to be within the scope and spirit of the present invention as defined by the flowing claims and their legal equivalents.

We claim:

1. A cookware comprising:
a. A cookware body, wherein said body comprising a base and a wall, whereby the wall extends from a top side of said base and spans a perimeter of said base;
b. At least one linear pattern of flame guiding channels connected perpendicularly to a bottom side of said base, wherein said flame guide channel comprises a pair of guide fins;

2. The cookware of claim 1, wherein said guide fins of said flame guide channel have a height to be larger than the distance between them.

3. The cookware of claim 1, wherein the flame entrance impedance of said flame guide channels is less than 0.8.

4. The cookware of claim 1, wherein the width of said flame guide channel varies across the said base.

5. The cookware of claim 1, wherein the top of said guide fin of said flame guide channel is not flat.

6. The cookware of claim 1, wherein a handle is attached to said wall in a location not above the exit of the said flame guide channels.

7. The cookware of claim 1, wherein protection coating is formed onto inside, outside surface of said wall and base, the thickness of coating on said outside surface is substantially thinner.

8. The cookware of claim 7, wherein said coating on said inside surface is a spray coated stainless steel layer.

9. A cookware comprising:
a. A cookware body, wherein said body comprising a rectangular base and a wall, whereby the wall extends from a top side of said base and spans a perimeter of said base;
b. At least one linear pattern of flame guide channels connected perpendicularly to a bottom side of said base, wherein said flame guide channel comprises a pair of guide fins, wherein the guide fins run in direction of an edge of said base.

10. The cookware of claim 9, wherein said guide fins of said flame guide channel have a height to be larger than the distance between them.

11. The cookware of claim 9, wherein the flame entrance impedance of said flame guide channels is less than 0.8.

12. The cookware of claim 9, wherein the width of said flame guide channel varies across the said base.

13. The cookware of claim 9, wherein the top of said guide fins of said flame guide channels is not flat.

14. The cookware of claim 9, wherein a handle is attached to said wall in a location not above the exit of the said flame guide channels.

15. The cookware of claim 9, wherein protection coating is formed onto inside, outside surface of said wall and base, the thickness of the coating on outside surface is substantially thinner.

16. The cookware of claim 15, wherein the coating on the inside surface is a spray coated stainless steel layer.

17. A method of forming an energy efficient cookware comprising:
a. Providing an extruded base wherein at least one linear pattern of flame guide channels connected perpendicularly to the bottom side of said base, wherein said flame guide channel comprises a pair of guide fins;
b. Providing a wall which has an upper rim and a lower rim;
c. Joining the lower rim of said wall to the edge of said base.

18. Method of claim 15, wherein the joining of the wall to said base is performed by electric arc welding.

19. Method of claim 15, wherein the joining of the wall to said base is performed by friction stir welding or laser welding.

20. A method of forming an energy efficient cookware comprising:
a. Providing an extruded member wherein at least one linear pattern of flame guide channels connected perpendicularly to the bottom side of said member, wherein said flame guide channel comprises a pair of guide fins;
b. Providing a stainless vessel body having a base, wherein a wall is extended from the rim of said base;
c. Attaching said extruded member to the bottom base of said stainless steel vessel by a roller press bond process, wherein the roller press used in the process having a ridge pattern complementary to that of said flame guide channels of said member.
